(19) United States
(12) Patent Application Publication
(10) Pub. No.: US 2019/0310355 A1
(43) Pub. Date: Oct. 10, 2019

(54) LIGHT DETECTION AND RANGING (LIDAR) SCANNERS FOR MOBILE PLATFORMS

(71) Applicant: Intel Corporation, Santa Clara, CA (US)

(72) Inventor: Grégoire Kerr, Germering (DE)

(21) Appl. No.: 16/438,993

(22) Filed: Jun. 12, 2019

(51) Int. Cl. G01S 7/497; G01S 17/58; G01S 17/88; B64C 39/02; G05D 1/00

(52) U.S. Cl. CPC G01S 7/4972; G01S 17/58; G05D 1/0094; B64C 39/024; G01S 17/88

(57) ABSTRACT

Light detection and ranging (LIDAR) scanners for mobile platforms is disclosed. An example apparatus for use with a movable platform includes a LIDAR scanner having a transmitter and a receiver, and a reflector having a reflective surface downstream from the LIDAR scanner, where the reflective surface is angled relative to the LIDAR scanner to reflect signal output by the transmitter toward an area of interest.

### FIELD OF THE DISCLOSURE

This disclosure relates generally to scanners and, more particularly, to light detection and ranging (LIDAR) scanners for mobile platforms.

### BACKGROUND

Unmanned aerial vehicles (UAVs) and unmanned ground based vehicles (UGVs), collectively and individually referred to herein as drones, are becoming more readily available. Similarly, robots are becoming more available for consumer and industrial applications. Indeed, the market for drones and robots is rapidly growing. Drones and robots are now being used in a wide variety of industries, such as farming, shipping, forestry management, surveillance, disaster relief, gaming, photography, marketing, etc.

### BRIEF DESCRIPTION OF THE DRAWINGS

FIG. 1 illustrates a known area scanning technique.

FIG. 2 is a perspective view of an example unmanned aerial vehicle (UAV) constructed in accordance with teachings of this disclosure.

FIG. 3 illustrates an example scanning system of the example drone of FIG. 2.

FIG. 4 illustrates an alternative example scanning system that can be implemented in examples disclosed herein.

FIG. 5 illustrates yet another alternative example scanning system that can be implemented in examples disclosed herein.

FIG. 6 illustrates an example navigation and scanning control system that can be implemented in examples disclosed herein.

FIG. 7 is a flowchart representative of example machine readable instructions which may be executed to implement examples disclosed herein.

FIG. 8 is a block diagram of an example processing platform structured to execute the instructions of FIG. 7 to implement the example drone of FIG. 2 and/or the example navigation and scanning control system of FIG. 6.

The figures are not to scale. Instead, the thickness of the layers or regions may be enlarged in the drawings. In general, the same reference numbers will be used throughout the drawing(s) and accompanying written description to refer to the same or like parts. As used in this patent, stating that any part is in any way on (e.g., positioned on, located on, disposed on, or formed on, etc.) another part, indicates that the referenced part is either in contact with the other part, or that the referenced part is above the other part with one or more intermediate part(s) located therebetween. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. Stating that any part is in “contact” with another part means that there is no intermediate part between the two parts.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

In some known systems, a vehicle, such as a manned vehicle (e.g., an automobile with a drive assist feature), an unmanned aerial vehicle (UAV), or an unmanned ground vehicle (UGV) scans, measures and/or detects objects or terrain of an area (e.g., a zone of interest) by use of a rotating LIDAR scanner, which transmits a LIDAR signal (e.g., a light signal) and utilizes corresponding reflections to determine a presence of an object and/or surface. However, rotating LIDAR scanners in these known systems transmit LIDAR signals to areas that do not reflect the LIDAR signals, thereby wasting time, energy and/or other resources. In particular, these areas can be out of signal range and/or correspond to the Earth's atmosphere.

Examples disclosed herein increase scanning efficiency of a reflection-based scanning system by utilizing a reflector (e.g., a mirror) to narrow or focus an angular scanning area of the LIDAR signals. According to examples disclosed herein, a LIDAR system having a rotating LIDAR scanner is operated in conjunction with a reflector to focus signals (e.g., light signals) associated with the LIDAR scanner to within a desired angular range, area and/or zone of interest. In other words, the reflector narrows an angular scanning area of the rotating LIDAR scanner, thereby preventing LIDAR signals from being transmitted toward objects and/or ground that are out of a range (e.g., beyond a reflection range) of the LIDAR scanner. Examples disclosed herein can be used to increase accuracy of LIDAR scanning by focusing the angular area in which LIDAR signals are transmitted to and, thus, increasing an amount of LIDAR signals transmitted to one or more area(s) or zone(s) of interest. Thus, examples disclosed herein improve the operation of a LIDAR system. Such an improved system may be employed with any movable platform such as a robot, manned vehicle (e.g., a drive assist system, a collision avoidance system, a warning system, etc.), and/or drone, for example, to improve avoidance of a collision, improve terrain and/or object detection, etc. As such, examples disclosed herein improve the operation of a machine.

In some examples, the reflector and/or a reflective surface of the reflector is planar (e.g., not curved such that its shape is aligned in one or more parallel planes). In some examples, the reflector and/or the reflective surface is angled from a rotation of axis of the LIDAR scanner. In some examples, the reflector exhibits a concavity (e.g., a concave curved surface) with an opening of the concavity facing toward the LIDAR scanner. In some examples, an orientation of the reflector is affected by an actuator to change, move and/or vary an angular scanning area of the LIDAR scanner. In some such examples, the orientation of the reflector is adjusted further based on movement (e.g., speed or acceleration) of a movable platform (e.g., a drone, a robot, a mobile platform, etc.) and/or a vehicle (e.g., a passenger vehicle, a bus, etc.) to which the LIDAR scanner is mounted.

As used herein, the term “LIDAR scanner” refers to a scanning device, assembly and/or system to transmit a signal and utilize a reflection of that signal to determine a presence of an object and/or a surface. As used herein the term “signal” in the context of reflection-based sensing or scanning (e.g., a LIDAR implementation) refers to any form of waves including, for example, an audio signal, sound, electromagnetic waves, light, etc., transmitted from a scanning device. As used herein, the term “actuator” refers to a device, component and/or assembly to cause or otherwise direct motion of an object. Accordingly, the term “actuator” can include, but is not limited to, a motor, a solenoid, a propeller, an engine, an electromagnetic device, etc. As used herein, the term “downstream” refers to one or more positions of a transmission path following a transmitter by any distance. A reflected signal returning toward a transmitter is downstream from the transmitter. A signal output by the transmitter is downstream from the transmitter.

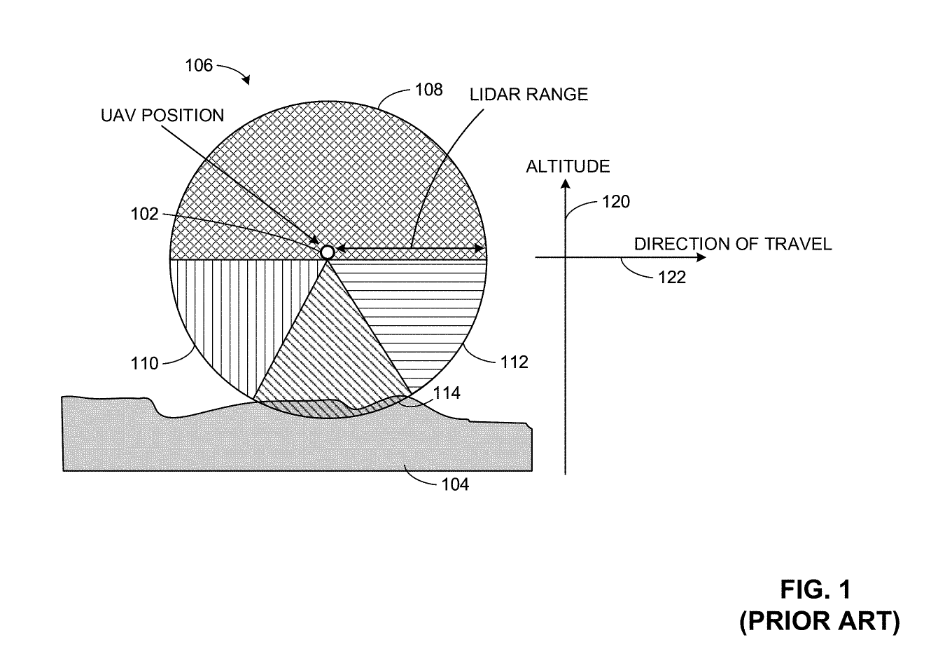

FIG. 1 illustrates a known area scanning technique. In this known technique, a movable platform e.g., a UAV) 102 is shown flying over a ground surface 104 that is being scanned by a LIDAR scanning system of the UAV 102. The range of the LIDAR is represented by the radius of a sphere, one plane of which is shown by a circle 106 in the two-dimensional drawing of FIG. 1. In particular, this spherical area is defined by rotation of the LIDAR scanning system. The circle 106 depicts the total angular scanning area of the LIDAR scanning system of the UAV 102 in the plane of the paper of FIG. 1. The range representation includes respective portions 108, 110, 112, 114, all of which are shown in different crosshatching. A vertical axis 120 of FIG. 1 represents an altitude of the UAV 102. Further, a horizontal axis 122 represents a direction of travel that defines generally horizontal and/or lateral motion (in the view of FIG. 1).

The portion 108 of the range representation circle 106 depicts LIDAR signals that are transmitted upward and, thus, lost to the atmosphere. Similarly, the portions 110, 112 depict a range of LIDAR signals that are directed toward the ground 104, but still far enough from the ground 104 or at such an oblique angle that the LIDAR signals are not reflected back to the UAV 102. The portion 114 represents a zone in which the LIDAR signals are reflected back toward the UAV 102. The reflected signals of the portion 114 are utilized for scanning. The signals of the portions 108, 110, 112 are not reflected and, thus, are not utilized for scanning. Accordingly, in this known technique, the portion 114 of the LIDAR scanning circle that provides useful reflected signals is relatively small in comparison to the entire range of the circle 106. Because the LIDAR system would not be restricted to the plane of the paper but instead would be sent throughout the spherical area, the percentage of the LIDAR signals reflected back relative to the LIDAR signals that are emitted is relatively low.

In contrast to the known technique depicted in FIG. 1, examples disclosed herein utilize a reflector (e.g., a mirror) to focus, confine and/or narrow an angular range or area (e.g., an angular scanning area, etc.) in which the LIDAR signals are dispersed, thereby reducing a total scanning time and/or reducing unused LIDAR signals (e.g., reducing the amount of LIDAR signals that are not reflected back to the LIDAR scanning system).

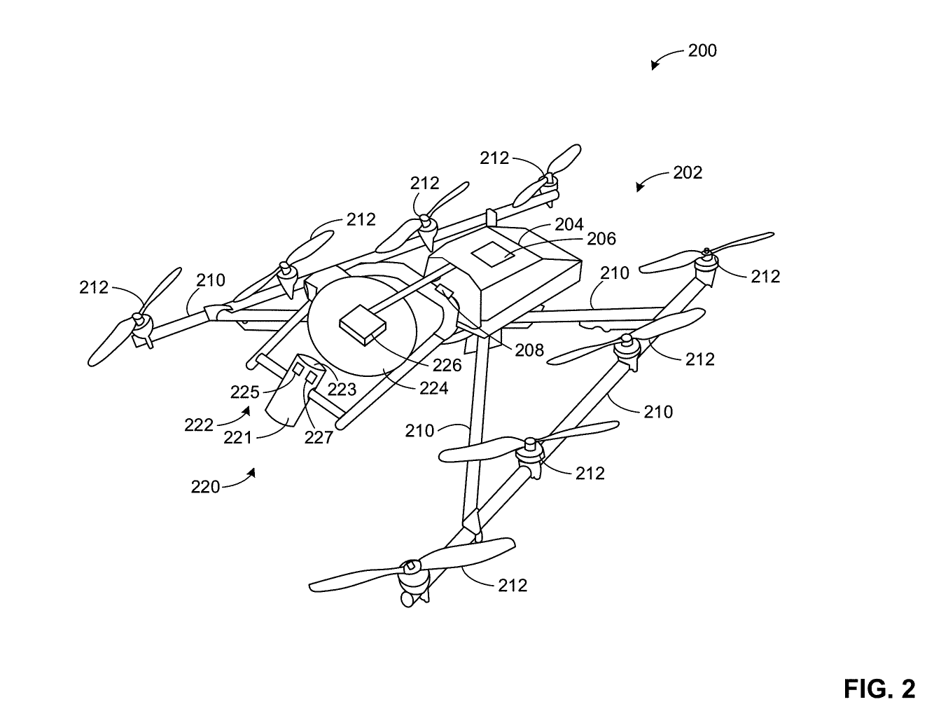

FIG. 2 is a perspective view of an example unmanned aerial vehicle (UAV) 200 structured in accordance with teachings of this disclosure. The UAV 200 of the illustrated example includes a body (e.g., a chassis, a center frame, a main body, etc.) 202, which includes a body housing 204, a processor (e.g., a UAV controller, a flight controller, etc.) 206, and a mount (e.g., a camera mount, a sensor mount, a modular mount) 208. Further, the example UAV 200 also includes chassis arms (e.g., supports, frame supports, etc.) 210 that mount corresponding rotor assemblies (e.g., DC motor-driven rotor assemblies) 212. According to the illustrated example of FIG. 2, the UAV 200 includes a LIDAR scanning system (e.g., a LIDAR assembly) 220 mounted thereto. Although a specific UAV 200 is shown in FIG. 2, any other movable platform may be used instead. For example, any other drone, UAV, UGV and/or robot can be substituted for the UAV 200.

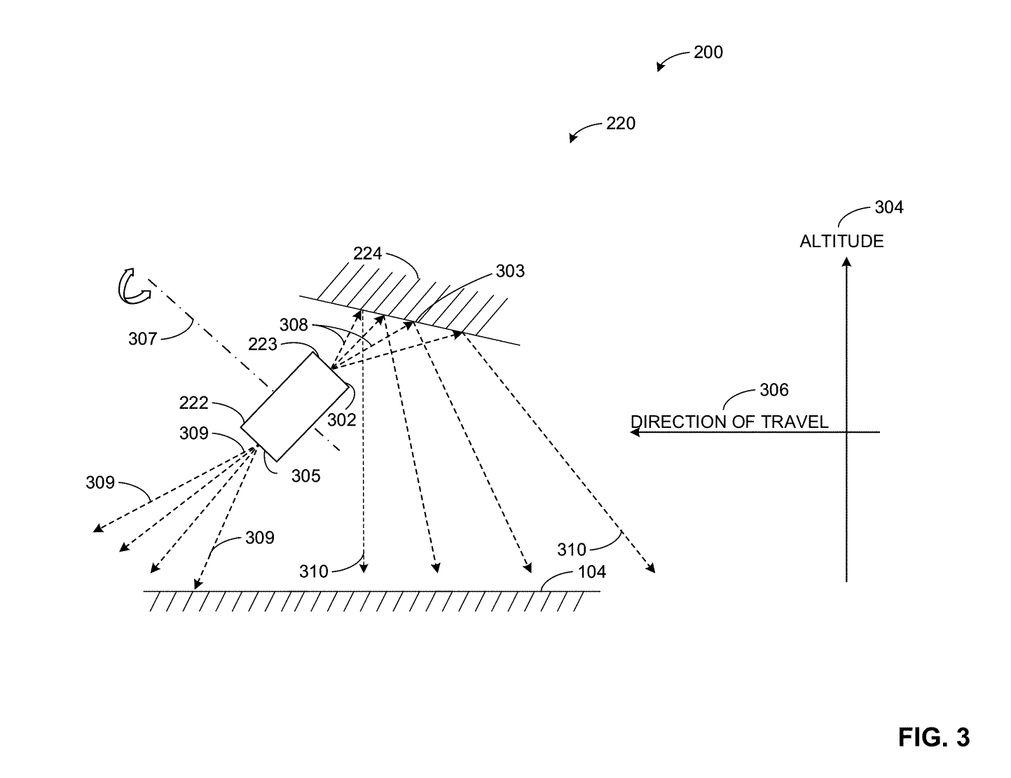

The example LIDAR assembly 220 includes a LIDAR scanner 222 including a housing 221. The housing 221 carries an emitting portion (e.g., an output, a signal discharge surface, a transmitting area or surface, etc.) 223, a transmitter 225 and a receiver 227. The transmitter 225 transmits signals and the receiver 227 receives reflections of the signals (when present). The LIDAR assembly 220 also includes a reflector (e.g., a reflector plate, a reflector mirror, etc.) 224. The reflector 224 is implemented as a mirror in this example. In some examples, the LIDAR assembly 222 also includes an actuator 226 operatively coupled to the reflector 224 to cause movement of the reflector 224. As will be discussed in greater detail below in connection with FIGS. 3-7, the reflector 224, which is positioned proximate the LIDAR scanner 222, is implemented to narrow and/or focus an angular scanning area of the LIDAR scanner 222 to reduce misdirection of LIDAR signals toward areas that would otherwise not ordinarily reflect their signals back to the LIDAR scanner 222. For example, scanner efficiency can be increased by reducing scanning time that would be otherwise spent waiting for LIDAR signals transmitted towards a non-reflecting zone (e.g., toward the sky and/or toward objects and/or surfaces that are out of LIDAR reflection ranges). Moreover, scanning areas where structures are elevated (e.g., from ground) still receive LIDAR signals and, as a result, little or no signal information is lost. As a result, the UAV 200 can move at a relatively faster speed based on the aforementioned reduced scanning time while gathering a similar amount (e.g., the same as the known system of FIG. 1). In turn, mission time of the UAV 200, and, thus, the associated fuel consumption and monitoring costs can be reduced.

In some examples, the actuator 226 is implemented as a motor, a solenoid, and/or an electromagnet. The actuator 226 of the example of FIG. 2 drives movement (e.g., rotational movement and/or translation movement) of the reflector 224 to adjust, limit and/or re-orient an angular range (e.g., an angular scanning area, a scanning zone) of the LIDAR scanner 222. In particular, the actuator 226 rotates and/or otherwise orients the reflector 224 to control an orientation, and/or size of the angular range in which the LIDAR signals are dispersed. For example, rather than sending signals throughout the entire sphere discussed in connection with FIG. 1, the reflector 224 directs the LIDAR signals toward an area of interest such as the portion 114, which is able to reflect such signals for detection. The example reflector 224 directs the LIDAR signals away from (e.g., blocks) some or all of the areas that cannot reflect such LIDAR signals back for detection, such as portions 108, 110, 112 of FIG. 1. Additionally or alternatively, the actuator 226, in some examples, displaces and/or alters a shape (e.g., elastically alters the shape, pushes against, stretches or compresses, deforms, etc.) of the reflector 224 to change and/or vary the angular range of the LIDAR scanner 222. In some examples, the actuator 226 causes a translational movement of the reflector 224.

While the example movable platform shown in FIG. 2 is implemented as a UAV, examples disclosed herein can be implemented on any other type of movable/mobile platform including, but not limited to, an automobile, a hovercraft, a boat, a submarine, a fixed-wing aircraft, a manned aircraft, a robot, an unmanned ground vehicle, etc. Further, while the example of FIG. 2 is directed to LIDAR scanning, examples disclosed herein can be implemented to any other type of reflection-based scanning, including scanning based on sound or vibrational reflections, for example.

FIG. 3 illustrates the example scanning system 220 of the example UAV 200 of FIG. 2. In the illustrated view, the scanning system 220 is shown with the LIDAR scanner 222 having an emission surface (e.g., an output surface) 302 at the emitting portion 223 currently facing a reflective surface 303 of the reflector 224 and a second emissive surface 305 currently facing the ground surface (e.g., Earth) 104. Further, a vertical axis 304 shown in FIG. 3 corresponds to an altitude of the UAV 200 while a horizontal axis 306 corresponds to a direction of travel (e.g., a flight direction) of the UAV 200.

To transmit LIDAR signals along a generally circular (or spherical) pattern (in the plane of the paper), the LIDAR scanner 222 of the illustrated example is rotated about a rotational axis 307. Continuously, periodically or aperiodically, the LIDAR scanner 222 is operated in a sensing mode. As a result, signals transmitted from the opposite ends of the LIDAR scanner 222 are dispersed across a relatively large circular range. The circular area in which signals are transmitted is defined by the rotation of the LIDAR scanner 222. Beams 309 are emitted from the UAV 200 toward the ground. Ordinarily, the upwardly directed signal or beams 308 in the position shown in FIG. 3 would be lost as they move into the atmosphere and are not reflected back to the LIDAR scanner 222. However, as can be seen in the illustrated example of FIG. 3, The beams 308 are emitted toward the reflective surface 303 of the reflector 224 at an oblique angle (e.g., an obtuse angle) and are, thus, reflected at a different orientation from the emitting portion 223. As a result, the beams 309, 310 from both ends of the emitters 223, 305 are directed toward the ground 104. As a result, the usually directed signals/beams 308 are not lost into the atmosphere by being directed away from the surface of interest (e.g., ground).

In this example, the reflector 224 is a planar reflector. To reflect and re-direct the beams 310 from the emitting portion 223 of the LIDAR scanner 222, the reflective surface 303 of the reflector 224 of the illustrated example is angled from the rotational axis 307 and/or the emission surface 302 to cause the beams 310 to be directed generally downward (in the view of FIG. 3) toward the ground 104. In this particular example, the reflection of the beams 310 results in the angular range area of the LIDAR scanner 222 having a cone-like-shape. Accordingly, the beams 308 of the illustrated example are not permitted to continue to travel in a generally upward direction (in the view of FIG. 3) from the UAV 200. Further, in this example, the rotational axis 307 of the LIDAR scanner 222 is angled from (e.g., tilted away from, inclined from) the direction of travel (e.g., the axis 306). Additionally or alternatively, the reflector 224 is angled relative to the ground 104. In some examples, the angular scanning area relative to the sphere shown in FIG. 1 is reduced to an angular scanning area of 25 to 45 degrees (e.g., a cone represents the angular scanning area). As used herein, the terms “cone-shaped” and “cone-like” refer to a dispersion angle of beams.

In some examples, the reflector 224 reflects light in the infrared (IR) wavelength range. In some examples, the actuator 226 shown in FIG. 2 is used to move and/or orient the reflector 224 (e.g., by gears, linkages and/or movable posts, swivel joints, etc.) to further adjust the aforementioned resultant angular sensing range over time. In some examples, a rotational speed and/or angular speed of the scanner 222 is changed and/or varied based on movement of the UAV 200 (e.g., based on, in proportion to a movement speed and/or velocity of the UAV 200) and/or a desired degree of scanning of an object and/or surface.

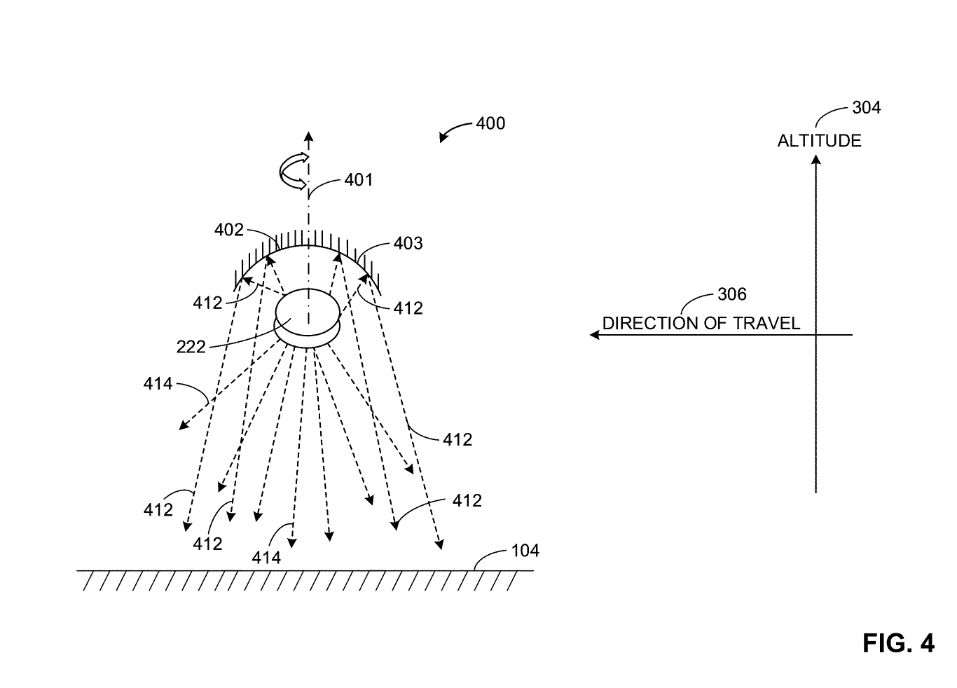

FIG. 4 illustrates an alternative example scanning system 400. In some examples, features described in connection with the example scanning system 400 can be combined with the scanning system 300 of FIG. 3. In the illustrated example, the scanning system 400 includes the LIDAR scanner 222 that rotates about an axis of rotation 401. Further, the example scanning system 400 includes a reflector 402. The reflector 402 of this example is curved in shape, as opposed to the planar shape of the reflector 224 described above in connection with FIGS. 2 and 3. In particular, the reflector 402 includes at least one curved reflective surface 403 facing toward (e.g., open toward) the LIDAR scanner 222. For example, the curved reflective surface 403 can be a curved mirror, a parabolic mirror, a concave surface, a mirror curved in multiple dimensions, a surface or contour having distinct curved portions, etc. In the illustrated example, the reflector 402 is shown relative to the axis 304 that corresponds to an altitude of the UAV 200 and the axis 306 corresponds to a direction of travel of the UAV 200.

To reflect LIDAR signals from the LIDAR scanner 222 while the LIDAR scanner 222 rotates about the axis of rotation 401, the example reflective surface 403 of the reflector 402 is positioned adjacent the LIDAR scanner 222. The reflector 402 of this example exhibits a concave shape (e.g., includes a concavity, a curved concave shape, etc.) and is positioned above (in the view of FIG. 4) the LIDAR scanner 222 facing downward toward (e.g., is open toward) the LIDAR scanner 222. In other words, the reflector 402 and/or the reflective surface 403 is curved relative to the LIDAR scanner 222 and/or the axis of rotation 401. In this example, the LIDAR scanner 222 transmits LIDAR signal beams 412, 414. In particular, the LIDAR signals 412 are initially reflected upward away from ground (e.g., Earth) and then reflected downward (in the view of FIG. 4). The beams 414 are initially transmitted downward based on a current angular rotation of the LIDAR scanner 222, and, thus, do not reflect from the reflective surface 403.

In some examples, a center (e.g., a geometric center, etc.) of the concave shape of the reflector 402 is aligned with a center of the LIDAR scanner 222 and/or the axis of rotation 401. In some examples, the actuator 226 shown in FIG. 2 moves, orients and/or changes a shape of the reflector 402 in response to the processor 206 directing a change in orientation of the scanning area and/or the processor 206 directing a desired change in angular scanning area (e.g., to narrow the scanning area, to widen the scanning area, etc.). In some such examples, the actuator 226 pushes and/or moves at least a portion of the reflector 402 to adjust a curvature of the reflective surface 403 of the reflector 402 to change an angular scanning area of the LIDAR scanner 222. In some examples, the concave shape of the reflective surface 403 is combined with the inclined reflective surface 303 shown in FIG. 3. In particular, the cross-sectional views of FIGS. 3 and 4 may be the same scanning system (e.g., cross-sectional views of the same system that are perpendicular to one another), thereby defining a reflective surface that is both angled (e.g., angled from the LIDAR scanner 222) and exhibiting a curvature (e.g., a curvature along multiple directions).

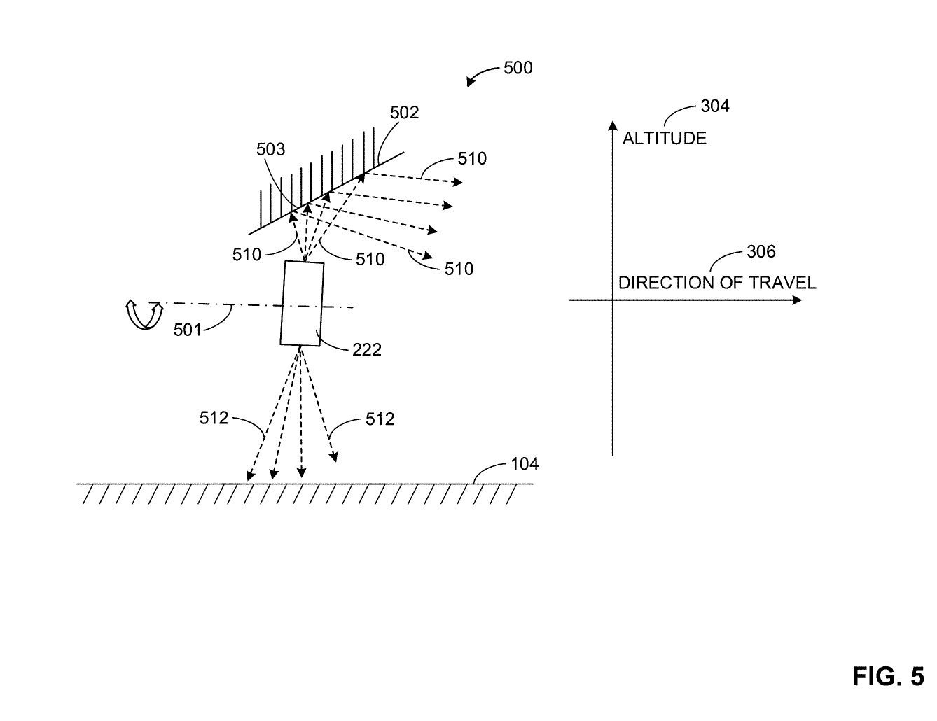

FIG. 5 illustrates another alternative example scanning system 500. The example scanning system 500 of FIG. 5 is similar to the example scanning system 220 of FIGS. 2 and 3, but utilizes scanning along a direction of travel instead of scanning the ground 104. In other words, the scanning system 500 is implemented to scan toward a general direction of movement of the UAV 200. In some examples, additional scanning is performed of the ground 104 via beams 512. In the illustrated example of FIG. 5, the scanning system 500 includes the LIDAR scanner 222 with a corresponding rotational axis 501. The scanning system 500 also includes a reflector (e.g., a flat mirror, a planar mirror, etc.) 502, which is planar (e.g., relatively flat) and includes a reflective surface 503.

In operation, as the LIDAR scanner 222 rotates about the rotational axis 501, beams 510 are reflected from the reflector 502 and travel along a direction that is relatively close to the direction of travel represented by the horizontal axis 306 (e.g., within 20 degrees from the axis 306). As a result, the LIDAR scanner 222 is able to scan for objects and/or surfaces positioned along or proximate the direction of travel represented by the axis 306, for example. In other words, the LIDAR scanner 222 can be used to scan an area generally in front of the UAV 200 as the UAV 200 moves along the aforementioned direction of travel corresponding to the axis 306. Further, the beams 512 are directed away toward the ground 104 from the reflector 502 based on a current depicted rotational angle of the LIDAR scanner 222. Accordingly, in some examples, both a generally downward facing scanning angular area, as well as a generally forward facing scanning angular area can be simultaneously scanned by the LIDAR scanner 222.

In some examples, the reflector 502 is concave and/or exhibits an otherwise curved shape. In some examples, the rotational axis 501 is generally aligned with (e.g., within 10 degrees of) the direction of travel (e.g., the axis 306). Further, any of the example features and/or details shown and described in connection with FIGS. 3-5 can be implemented with any other of the examples.

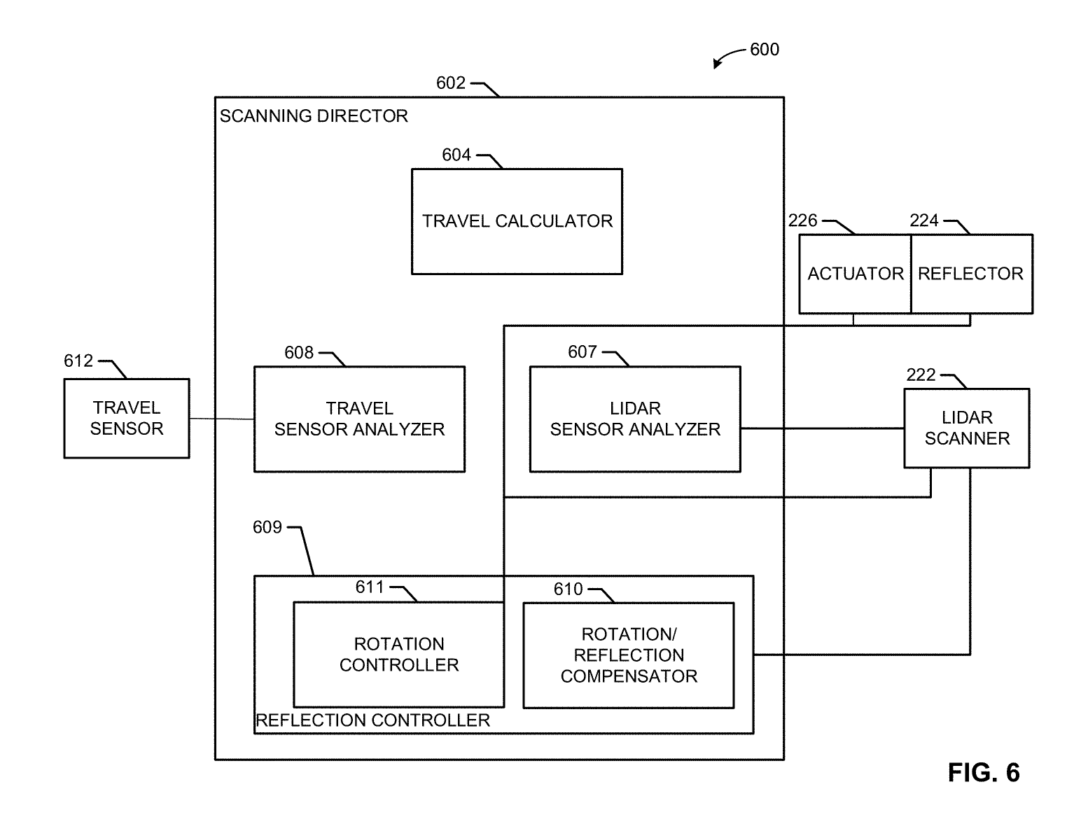

FIG. 6 illustrates an example navigation and scanning control system 600. The navigation and scanning control system 600 can be implemented by the processor 206 shown in FIG. 2, by a local or remote control device (e.g., a remote control device, a remote control server, etc. or by any other appropriate logic circuitry preset in and/or remote from the vehicle being supported (e.g., the UAV 200). for example, or any other appropriate logic circuitry, and/or local or remote control device (e.g., a remote control device, a remote control server, etc.). The example navigation and scanning control system 600 of FIG. 6 includes a scanning director 602. The scanning director 602 of the example includes a travel calculator 604, and a LIDAR sensor data analyzer 607. The LIDAR sensor data analyzer 607 is communicatively coupled to the LIDAR scanner 222 in this example. Further, the example navigation and scanning control system 600 also includes a travel sensor analyzer 608, and a reflector controller 609. The example reflector controller 609 includes a rotation/reflection compensator 610 and a rotation controller 611. Further, in this example, the example navigation and scanning control system 600 is in communication with a travel sensor 612.

The travel calculator 604 of the illustrated example determines a travel path (e.g., a flight path) of the vehicle being serviced (e.g., the UAV 200). In particular, the travel calculator 604 determines a travel path so that the vehicle in question can scan an area of interest with the LIDAR scanning system 220. In some examples, the travel calculator 604 determines a speed and/or velocity of the vehicle (e.g., the UAV 200) based on a desired amount of scanning to be performed on the area of interest.

The example LIDAR sensor analyzer 607 of FIG. 6 analyzes sensor data from the LIDAR scanner. In some examples, the LIDAR sensor analyzer 607 determines whether the LIDAR scanner 222 will be able to obtain sufficient sensor readings based on an orientation of the LIDAR scanner 222, an orientation of a corresponding reflector, the flight path and/or the angular speed at which the LIDAR scanner 222 rotates. In some such examples, the sensor LIDAR analyzer 607 directs or causes the travel calculator 604 to determine a change in movement (e.g., a change in speed, a change in heading, etc.) of the vehicle (e.g., the UAV 200) to enable sufficient LIDAR readings. Additionally or alternatively, the LIDAR sensor analyzer 607 determines whether potential areas of interest to scan will likely be out of LIDAR range and, thus, movement of the vehicle (e.g., the UAV 200) is to be adjusted (e.g., the vehicle is to fly lower). In some examples, the LIDAR sensor analyzer 607 determines a recommended flight path and/or speed of the vehicle (e.g., the UAV 200) to obtain sufficient LIDAR readings.

The travel sensor analyzer 608 of the illustrated example gathers sensor data related to movement of the vehicle (e.g., the UAV 200). In particular, the travel sensor analyzer utilizes data (e.g., flight data) from the travel sensor 612 to determine a travel (e.g., flight) path for the vehicle (e.g., the UAV 200). In some examples, this determination is based on a desired amount of scanning and/or environmental conditions detected by the travel sensor 612 that can impact scanning (e.g., visibility conditions, occlusions, terrain topography, etc.).

In some examples, the reflector controller 609 controls the actuator 226 and, in turn, movement, displacement and/or deformation of the reflector 224 to adjust an orientation and/or an angular dispersion of beams emitted from the LIDAR scanner 222. Additionally or alternatively, the reflector controller 609 causes the actuator 226 to cause a translational movement of the reflector 224 relative to the scanner 222 in response to a desired change in angular scanning area, for example.

In the illustrated example of FIG. 6, the rotation/reflection compensator 610 adjusts (e.g., corrects, augments, supplements) sensor data from the LIDAR scanner 222 based on a rotational speed of the LIDAR scanner 222 and/or a determined scanning area based on reflections from the reflector 224. In particular, the rotation/reflection compensator 610 can adjust sensor data based on a known rotational rate speed of the LIDAR to compensate for movement of the vehicle (e.g., the UAV 200).

In the illustrated example, the rotation controller 611 controls a rotational movement of the LIDAR scanner 222. For example, the rotation controller 611 of this example calculates an angular speed at which to rotate the LIDAR scanner 222 based on a desired amount of scanning of an area of interest. For example, increased scanning requirements will require faster rotation of the LIDAR scanner 222 and/or a lower speed of travel of the vehicle (e.g., the UAV 200). Additionally or alternatively, the angular speed of rotation of the LIDAR scanner is based on a travel velocity or speed of the vehicle (e.g., the UAV 200) (e.g., to ensure that the area of interest is sufficiently scanned). In some other examples, the rotation controller 611 controls a direction of rotation of the LIDAR scanner 222 (e.g., a clockwise or counter-clockwise rotation of the LIDAR scanner 222).

While an example manner of implementing the navigation and scanning control system 600 of FIG. 6 is illustrated in FIG. 6, one or more of the elements, processes and/or devices illustrated in FIG. 6 may be combined, divided, re-arranged, omitted, eliminated and/or implemented in any other way. Further, the example flight calculator 604, the example travel sensor analyzer 607, the example travel sensor analyzer 608, the example reflector controller 609, the example rotation/reflection compensator 610, the example rotation controller 611 and/or, more generally, the example navigation and scanning control system 600 of FIG. 6 may be implemented by hardware, software, firmware and/or any combination of hardware, software and/or firmware. Thus, for example, any of the example flight calculator 604, the example travel sensor analyzer 607, the example travel sensor analyzer 608, the example reflector controller 609, the example rotation/reflection compensator 610, the example rotation controller 611 and/or, more generally, the example navigation and scanning control system 600 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example, flight calculator 604, the example travel sensor analyzer 607, the example travel sensor analyzer 608, the example reflector controller 609, the example rotation/reflection compensator 610 and/or the example the example rotation controller 611 is/are hereby expressly defined to include a non-transitory computer readable storage device or storage disk such as a memory, a digital versatile disk (DVD), a compact disk (CD), a Blu-ray disk, etc. including the software and/or firmware. Further still, the example navigation and scanning control system 600 of FIG. 6 may include one or more elements, processes and/or devices in addition to, or instead of, those illustrated in FIG. 6, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

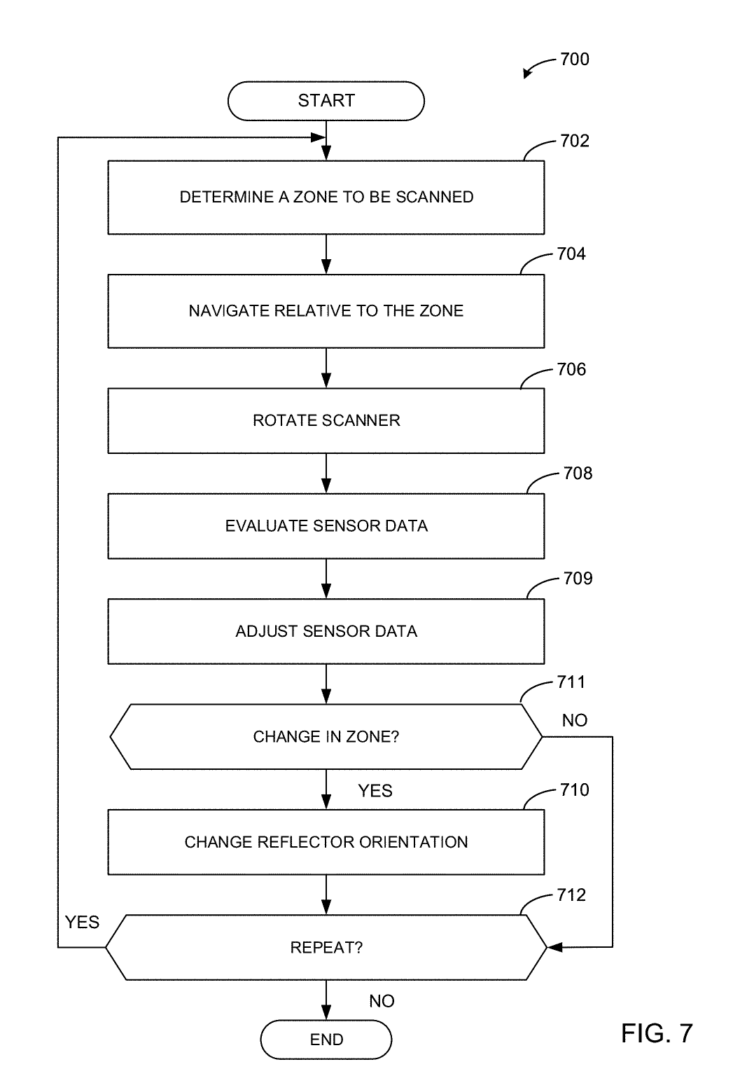

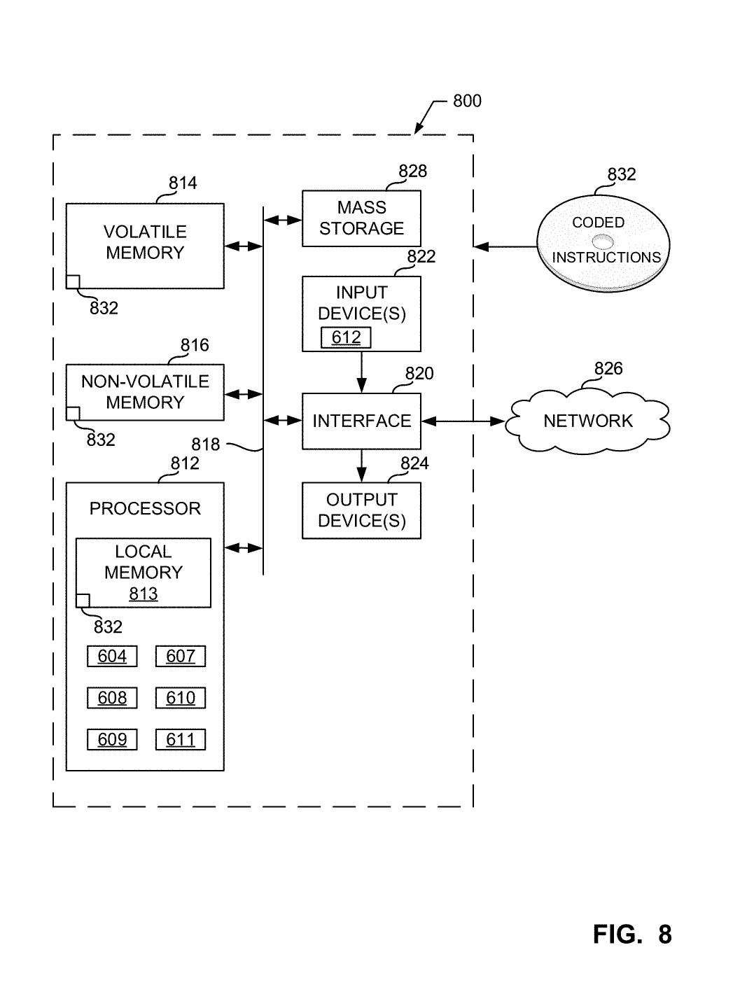

A flowchart representative of example hardware logic, machine readable instructions, hardware implemented state machines, and/or any combination thereof for implementing the navigation and scanning control system 600 of FIG. 6 is shown in FIG. 7. The machine readable instructions may be one or more executable programs or portion(s) of an executable program for execution by a computer processor such as the processor 812 shown in the example processor platform 800 discussed below in connection with FIG. 8. The program may be embodied in software stored on a non-transitory computer readable storage medium such as a CD-ROM, a floppy disk, a hard drive, a DVD, a Blu-ray disk, or a memory associated with the processor 812, but the entire program and/or parts thereof could alternatively be executed by a device other than the processor 812 and/or embodied in firmware or dedicated hardware. Further, although the example program is described with reference to the flowchart illustrated in FIG. 7, many other methods of implementing the example navigation and scanning control system 600 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine readable instructions described herein may be stored in one or more of a compressed format, an encrypted format, a fragmented format, a compiled format, an executable format, a packaged format, etc. Machine readable instructions as described herein may be stored as data (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement a program such as that described herein.

In another example, the machine readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, the disclosed machine readable instructions and/or corresponding program(s) are intended to encompass such machine readable instructions and/or program(s) regardless of the particular format or state of the machine readable instructions and/or program(s) when stored or otherwise at rest or in transit.

The machine readable instructions described herein can be implemented by any past, present, or future instruction language, scripting language, programming language, etc. For example, the machine readable instructions may be implemented using any of the following languages: C, C++, Java, C#, Perl, Python, JavaScript, HyperText Markup Language (HTML), Structured Query Language (SQL), Swift, etc.

As mentioned above, the example process of FIG. 7 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

The example instructions 700 of FIG. 7 includes block 702. At block 702, the flight calculator 604 and/or the sensor analyzer 608 determines a zone of interest (e.g., an area of interest) to be scanned by the LIDAR scanner 222. In this example, the flight calculator 604 determines a navigational path in which the LIDAR scanner 222 can be directed to scan the aforementioned zone (e.g., scan the zone for objects, surfaces and/or conditions associated with the zone).

At block 704, the travel calculator 604 of the illustrated example navigates a movable platform, such as the vehicle (e.g., the UAV 200), relative to the aforementioned zone. For example, the travel calculator 604 directs movement of the vehicle (e.g., the UAV 200) to scan an area of the zone (e.g., during a circling movement pattern, a patrolling movement pattern, etc.).

At block 706, the rotation controller 611 causes the LIDAR scanner 222 to rotate. In some examples, the rotation controller 611 varies a rotational speed of the LIDAR scanner 222 based on a desired degree of scanning and/or a speed of the vehicle. Additionally or alternatively, the rotation controller 611 varies a rotational speed of the LIDAR scanner 222 based on external conditions of the vehicle (e.g., weather conditions, visibility conditions, etc.).

In the illustrated example, at block 708, the LIDAR sensor analyzer 607 analyzes and/or evaluates sensor data from the LIDAR scanner 222. In some examples, the LIDAR sensor analyzer 607 determines whether sufficient data and/or data has been obtained (e.g., based on a desired level of object/surface scanning).

At block 709, the example rotation/reflection compensator 610 adjusts sensor data from the LIDAR scanner 222. In some examples, the sensor data is adjusted, truncated and/or corrected based on a degree of repetition or redundancy, a degree to which an area was scanned, etc.

At block 711, it is determined whether the zone of interest of interest has changed. If the zone of interest has changed (block 711), control of the process proceeds to block 710. Otherwise, the process proceeds to block 712. This determination may be based on whether the zone of interest has been scanned to a desired degree and/or whether a new area or zone to be scanned has been determined.

At block 710, in some examples, an orientation of a reflector (e.g., the reflector 224, the reflector 402, the reflector 502) and/or a reflective surface is changed (e.g., adjusted) by the reflector controller 609. In particular, the example reflector controller 609 directs the actuator 226 to adjust an orientation of the reflector operatively coupled thereto. In other examples, the reflector controller 609 causes the actuator 226 to deform (e.g., elastically deform, plastically deform) or translate the reflector.

At block 712, it is determine whether to repeat the process. If the process is to be repeated (block 712), control of the process proceeds to block 702. Otherwise, the process ends. This determination may be based on whether scanning performed by the vehicle (e.g., the UAV 200) has gathered sufficient data.

FIG. 8 is a block diagram of an example processor platform 800 structured to execute the instructions of FIG. 7 to implement the navigation and scanning control system 600 of FIG. 6. The processor platform 800 can be, for example, a server, a personal computer, a workstation, a self-learning machine (e.g., a neural network), a mobile device (e.g., a cell phone, a smart phone, a tablet such as an iPad), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 800 of the illustrated example includes a processor 812. The processor 812 of the illustrated example is hardware. For example, the processor 812 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example flight calculator 604, the example travel sensor analyzer 607, the example travel sensor analyzer 608, the example reflector controller 609, the example rotation/reflection compensator 610, and the example rotation controller 611.

The processor 812 of the illustrated example includes a local memory 813 (e.g., a cache). The processor 812 of the illustrated example is in communication with a main memory including a volatile memory 814 and a non-volatile memory 816 via a bus 818. The volatile memory 814 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 816 may be implemented by flash memory and/or any other desired type of memory device. Access to the main memory 814, 816 is controlled by a memory controller.

The processor platform 800 of the illustrated example also includes an interface circuit 820. The interface circuit 820 may be implemented by any type of interface standard, such as an Ethernet interface, a universal serial bus (USB), a Bluetooth® interface, a near field communication (NFC) interface, and/or a PCI express interface.

In the illustrated example, one or more input devices 822 are connected to the interface circuit 820. The input device(s) 822 permit(s) a user to enter data and/or commands into the processor 812. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 824 are also connected to the interface circuit 820 of the illustrated example. The output devices 824 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 820 of the illustrated example, thus, typically includes a graphics driver card, a graphics driver chip and/or a graphics driver processor.

The interface circuit 820 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 826. The communication can be via, for example, an Ethernet connection, a digital subscriber line (DSL) connection, a telephone line connection, a coaxial cable system, a satellite system, a line-of-site wireless system, a cellular telephone system, etc.

The processor platform 800 of the illustrated example also includes one or more mass storage devices 828 for storing software and/or data. Examples of such mass storage devices 828 include floppy disk drives, hard drive disks, compact disk drives, Blu-ray disk drives, redundant array of independent disks (RAID) systems, and digital versatile disk (DVD) drives.

The machine executable instructions 832 of FIG. 7 may be stored in the mass storage device 828, in the volatile memory 814, in the non-volatile memory 816, and/or on a removable non-transitory computer readable storage medium such as a CD or DVD.

Example 1 includes an apparatus for use with a movable platform. The apparatus includes a rotating light detection and ranging (LIDAR) scanner having a transmitter and a receiver, and a reflector having a reflective surface downstream from the LIDAR scanner, where the reflective surface is angled relative to the LIDAR scanner to reflect signal output by the transmitter toward an area of interest.

Example 2 includes the apparatus of Example 1, and further includes an actuator to move the reflective surface.

Example 3 includes the apparatus of Example 1, where the reflective surface exhibits a curved shape.

Example 4 includes the apparatus of Example 3, where the reflective surface is concave toward the LIDAR scanner.

Example 5 includes the apparatus of Example 1, where the reflective surface is planar, the reflective surface angled relative to an axis of rotation of the LIDAR scanner.

Example 6 includes the apparatus of Example 1, where the reflector is to reflect the signal within an infrared (IR) wavelength range.

Example 7 includes the apparatus of Example 1, where the movable platform includes at least one of an unmanned aerial vehicle (UAV), an unmanned ground vehicle (UGV), a manned vehicle or a robot.

Example 8 includes a method of scanning a zone of interest with a movable platform. The method includes rotating a light detection and ranging (LIDAR) scanner mounted to the movable platform along a rotational axis of the LIDAR scanner, where the LIDAR scanner includes a transmitter and a receiver. The method also includes reflecting, via a reflector downstream from the LIDAR scanner, signal output by the transmitter toward an area of interest, where the reflector has a reflective surface angled relative to the LIDAR scanner.

Example 9 includes the method of Example 8, and further includes changing, via an actuator, an orientation of the reflector to adjust a scanning area of the LIDAR scanner.

Example 10 includes the method of Example 9, where the orientation of the reflector is varied based on a speed of travel of the movable platform.

Example 11 includes the method of Example 9, where the orientation of the reflector is varied based on a desired degree of scanning.

Example 12 includes the method of Example 8, and further includes changing a rotational speed of the LIDAR scanner along the rotational axis based on a desired degree of scanning.

Example 13 includes the method of Example 8, and further includes changing a shape of the reflective surface to adjust a scanning area.

Example 14 includes the method of Example 13, where the scanning area is directed toward a flight direction of the movable platform.

Example 15 includes a non-transitory machine readable medium comprising instructions, which when executed, cause a processor to at least determine an area of interest, navigate a movable platform relative to the area of interest, and evaluate sensor data from a light detection and ranging (LIDAR) scanner having a transmitter and a receiver. The instructions also cause the processor to change, based on the evaluated sensor data, an orientation of a reflector having a reflective surface downstream from the LIDAR scanner, where the reflective surface is angled from LIDAR scanner to reflect signal output by the transmitter toward an area of interest.

Example 16 includes the non-transitory machine readable medium of Example 15, where the instructions cause the processor to direct an actuator to change a shape of the reflective surface.

Example 17 includes the non-transitory machine readable medium of Example 15, where the instructions cause the processor to change a rotational speed of the LIDAR scanner based on a desired degree of scanning or a speed of travel of the movable platform.

Example 18 includes the non-transitory machine readable medium of Example 15, where the instructions cause the processor to adjust the sensor data based on a degree to which the area of interest was scanned.

Example 19 includes the non-transitory machine readable medium of Example 15, where the movable platform is navigated relative to the area of interest based on a desired degree of scanning of the area of interest.

Example 20 includes the non-transitory machine readable medium of Example 15, where the movable platform is an unmanned aerial vehicle (UAV), and wherein the instructions cause the processor to move the orientation of the reflector toward a direction of movement of the UAV.

From the foregoing, it will be appreciated that example methods, apparatus and articles of manufacture have been disclosed that enable accurate and cost-effective scanning of areas or zones using movable platforms. Examples disclosed herein prevent transmission of signals from an object/surface scanner toward an area that will likely not reflect the signals, thereby saving time and energy (e.g., unused scanning energy for non-reflected transmitted signals) while allowing a movable platform carrying the scanner to travel at a faster speed. As a result, fuel, energy and/or time may be conserved. Further, examples disclosed herein can enable more accurate scanning of an area or zone of interest by confining a scanning area and/or angle of a reflection-based scanner and, thus, direct more scanning signals in the area per unit of time than known systems.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent. While examples disclosed herein are shown and described in the context of UAVs, examples disclosed herein can be applied to any appropriate vehicle or vessel. Further, examples disclosed herein can be applied to any type of reflection-based scanning.

The following claims are hereby incorporated into this Detailed Description by this reference, with each claim standing on its own as a separate embodiment of the present disclosure.

What is claimed is:

1. An apparatus for use with a movable platform, the apparatus comprising:
a rotating light detection and ranging (LIDAR) scanner having a transmitter and a receiver; and
a reflector having a reflective surface downstream from the LIDAR scanner, the reflective surface angled relative to the LIDAR scanner to reflect signal output by the transmitter toward an area of interest.

2. The apparatus as defined in claim 1, further including an actuator to move the reflective surface.

3. The apparatus as defined in claim 1, wherein the reflective surface exhibits a curved shape.

4. The apparatus as defined in claim 3, wherein the reflective surface is concave toward the LIDAR scanner.

5. The apparatus as defined in claim 1, wherein the reflective surface is planar, the reflective surface angled relative to an axis of rotation of the LIDAR scanner.

6. The apparatus as defined in claim 1, wherein the reflector is to reflect the signal within an infrared (IR) wavelength range.

7. The apparatus as defined in claim 1, wherein the movable platform includes at least one of an unmanned aerial vehicle (UAV), an unmanned ground vehicle (UGV), a manned vehicle or a robot.

8. A method of scanning a zone of interest with a movable platform, the method comprising:
rotating a light detection and ranging (LIDAR) scanner mounted to the movable platform along a rotational axis of the LIDAR scanner, the LIDAR scanner including a transmitter and a receiver; and
reflecting, via a reflector downstream from the LIDAR scanner, signal output by the transmitter toward an area of interest, the reflector having a reflective surface angled relative to the LIDAR scanner.

9. The method as defined in claim 8, further including changing, via an actuator, an orientation of the reflector to adjust a scanning area of the LIDAR scanner.

10. The method as defined in claim 9, wherein the orientation of the reflector is varied based on a speed of travel of the movable platform.

11. The method as defined in claim 9, wherein the orientation of the reflector is varied based on a desired degree of scanning.

12. The method as defined in claim 8, further including changing a rotational speed of the LIDAR scanner along the rotational axis based on a desired degree of scanning.

13. The method as defined in claim 8, further including changing a shape of the reflective surface to adjust a scanning area.

14. The method as defined in claim 13, wherein the scanning area is directed toward a flight direction of the movable platform.

15. A non-transitory machine readable medium comprising instructions, which when executed, cause a processor to at least:
determine an area of interest;
navigate a movable platform relative to the area of interest;
evaluate sensor data from a light detection and ranging (LIDAR) scanner having a transmitter and a receiver; and
change, based on the evaluated sensor data, an orientation of a reflector having a reflective surface downstream from the LIDAR scanner, the reflective surface angled from LIDAR scanner to reflect signal output by the transmitter toward an area of interest.

16. The non-transitory machine readable medium as defined in claim 15, wherein the instructions cause the processor to direct an actuator to change a shape of the reflective surface.

17. The non-transitory machine readable medium as defined in claim 15, wherein the instructions cause the processor to change a rotational speed of the LIDAR scanner based on a desired degree of scanning or a speed of travel of the movable platform.

18. The non-transitory machine readable medium as defined in claim 15, wherein the instructions cause the processor to adjust the sensor data based on a degree to which the area of interest was scanned.

19. The non-transitory machine readable medium as defined in claim 15, wherein the movable platform is navigated relative to the area of interest based on a desired degree of scanning of the area of interest.

20. The non-transitory machine readable medium as defined in claim 15, wherein the movable platform is an unmanned aerial vehicle (UAV), and wherein the instructions cause the processor to move the orientation of the reflector toward a direction of movement of the UAV.
